(19) United States
(12) Patent Application Publication
(10) Pub. No.: US 2014/0189424 A1
(43) Pub. Date: Jul. 3, 2014

(54) Apparatus and Method for Parity Resynchronization in Disk Arrays

(71) Applicant: OPTOSTA INC., Daejeon (KR)

(72) Inventors: Jaeki Sim, Daejeon (KR); Sung Hoon Baek, Chungbuk (KR)

(21) Appl. No.: 13/902,685

(22) Filed: May 24, 2013

(30) Foreign Application Priority Data
Dec. 28, 2012 (KR) 10-2012-0156454

(51) Int. Cl. G06F 11/10

(52) U.S. Cl. CPC G06F 11/1076
USPC 714/6.24

(57) ABSTRACT

A method for parity resynchronization in disk arrays, in which an intent log comprising a list of addresses of pieces of data stored in a data write cache is generated. The pieces of data of the data write cache are written to a disk while the pieces of data are withdrawn from the data write cache. When power supply is interrupted during writing of the data to the disk, a processor supplies power to the disk to resume an operation of the disk, checks whether parity mismatch has occurred on the data of the disk corresponding to the data address list, and corrects a parity mismatch block using a parity block. When the consistency of data is damaged by unexpected power interruption, data being written is compared with a pre-stored intent log, shortening the time required for parity resynchronization.

### CROSS-REFERENCE TO RELATED APPLICATIONS

This application claims priority to and the benefit of Korean Patent Application No. 10-2012-0156454 filed in the Korean Intellectual Property Office on Dec. 28, 2012, the entire content of which is incorporated herein by reference.

### FIELD OF THE INVENTION

Embodiments relate to an apparatus and method for parity resynchronization in disk arrays.

### BACKGROUND

A delay time occurring when data is transmitted between a processor that stores an application program and a rotating disk storage device has increased by up to 105 times a delay time in a normal state. In order to reduce such a delay time, prefetching has been used, in which, before a processor for executing an application program requests data from a disk storage device, the data can be used by a cache, and thus the operations of the processor and the disk storage device overlap each other.

Such prefetching is configured to combine a plurality of sequential read requests into a single read request, reducing the rotating operation of the disk storage device and the motion of a head, which require high cost.

Among disk arrays in which a plurality of disk storage devices are connected in parallel and which are used to reduce a delay time occurring between a processor and the disk storage devices, a Redundant Array of Independent Disks (RAID) is configured to have stripes, each comprising strips of independent disks.

When the supply of power is interrupted during the write operation of the RAID, a stripe in which consistency is damaged may occur. Thereafter, when a fault occurs in at least one of a plurality of disk storage devices, a problem arises in that accurate data cannot be recovered in a stripe having lost consistency.

### SUMMARY

The invention has been made keeping in mind the above problems occurring in the prior art, and an object of the invention is to improve data error recovery efficiency in disk arrays.

An embodiment of the invention provides an apparatus for parity resynchronization in disk arrays, comprising a disk array comprising a plurality of disks and a plurality of stripes, a write buffer for buffering pieces of data to be stored in the disk array, an intent log comprising addresses of the pieces of data buffered in the write buffer, and a processor for determining whether parity mismatch has occurred on the pieces of data corresponding to the data addresses stored in the intent log, and correcting an erroneous block corresponding to data on which it is determined that parity mismatch has occurred, wherein the processor determines whether parity mismatch has occurred on the disk array or corrects the erroneous block using normal blocks and a parity block.

Preferably, the pieces of data may be written to the disk array after the addresses of the data have been stored in the intent log.

Preferably, the intent log may be stored in the disk array.

Preferably, the intent log may be stored in a nonvolatile storage device located independently of the disk array.

Another embodiment provides a method for parity resynchronization in disk arrays, comprising generating an intent log comprising a list of addresses of pieces of data stored in a data write cache, writing the pieces of data of the data write cache to a disk while withdrawing the data from the data write cache, and when supply of power is interrupted during writing of the data to the disk, a processor supplying power to the disk to resume an operation of the disk, checking whether parity mismatch has occurred on the data of the disk corresponding to the data address list stored in the intent log, and correcting a parity mismatch block using a parity block.

Preferably, generating the intent log, writing and withdrawing the data, and checking the parity mismatch on the data and correcting the parity mismatch block may be sequentially processed.

Another embodiment provides an apparatus for parity resynchronization in disk arrays, comprising a disk array comprising a plurality of disks and a plurality of stripes, a data write cache for storing pieces of data to be written to the disks, a buffering write cache for buffering write-requested data, an intent log comprising addresses of the pieces of data stored in the data write cache, and a processor for determining whether parity mismatch has occurred on the pieces of data corresponding to the data addresses stored in the intent log, and correcting an erroneous block corresponding to data on which it is determined that parity mismatch has occurred, wherein the processor determines whether parity mismatch has occurred on the disk array or corrects the erroneous block using normal blocks and a parity block.

Another embodiment provides a method for parity resynchronization in disk arrays, comprising generating an intent log comprising addresses of pieces of data stored in a data write cache, writing the pieces of data of the data write cache to a disk while withdrawing the data from the data write cache, and buffering write-requested data provided by a user in a buffering write cache, and when supply of power is interrupted while writing the pieces of data of the data write cache to the disk, a processor supplying power to the disk to resume an operation of the disk, checking whether parity mismatch has occurred on the data of the disk corresponding to the data address list stored in the intent log, and correcting a parity mismatch block using a parity block.

Preferably, the method may additionally comprise, after generating the intent log, determining whether the data write cache is empty, and swapping contents of the buffering write cache for contents of the data write cache.

Preferably, generating the intent log, determining the data, swapping the data, writing the data, and checking the parity mismatch on the data and correcting the parity mismatch block may be sequentially processed.

Preferably, if swapping the data has been performed, generating the intent log may be performed again.

### BRIEF DESCRIPTION OF THE DRAWINGS

FIG. 1 is a disk array according to an embodiment of the invention;

FIG. 2 is a diagram showing the operation of a disk array according to an embodiment of the invention;

FIG. 3 is a schematic showing an apparatus for parity resynchronization in disk arrays according to an embodiment of the invention;

FIGS. 4 and 5 are flowcharts showing a method of parity resynchronization in disk arrays according to an embodiment of the invention;

FIG. 6 is a schematic showing an apparatus for parity resynchronization in disk arrays according to another embodiment of the invention; and

FIG. 7 is a flowchart showing a method of parity resynchronization in disk arrays according to another embodiment of the invention.

### DETAILED DESCRIPTION OF THE INVENTION

Embodiments of the invention will be described in detail with reference to the attached drawings.

Below, an apparatus for parity resynchronization in disk arrays according to an embodiment of the invention will be described with reference to the attached drawings.

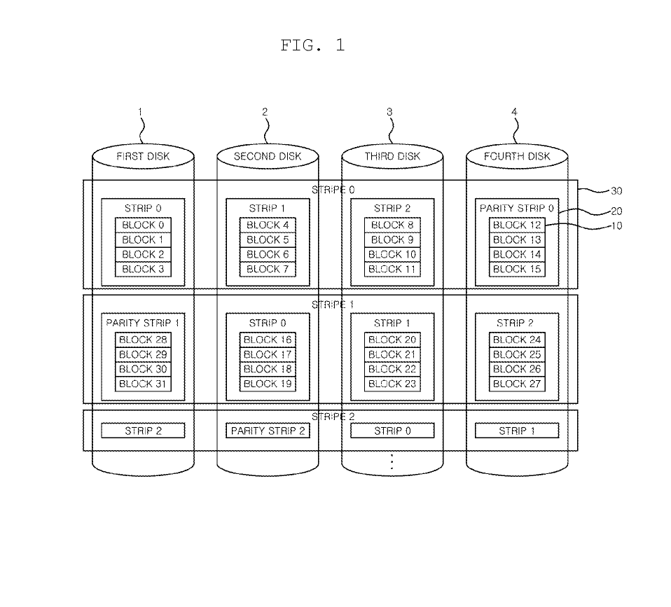

First, the structure of a disk array according to an embodiment of the invention will be described in detail with reference to FIG. 1.

As shown in FIG. 1, a Redundant Array of Independent Disks (RAID) structure, in which a plurality of independent disk storage devices (hereinafter referred to as ‘disks’) 1, 2, 3, and 4 are provided in the form of an array (hereinafter referred to as a ‘disk array’), is a single virtual disk storage device having a logical address space from the standpoint of a host. Such a disk array is configured to distribute data to a plurality of disk storage devices or store data therein.

Referring to FIG. 1, the disk array comprises first to fourth disks 1 to 4 arranged in parallel with each other.

The disks 1, 2, 3, and 4 are independently configured, and each of the disks 1, 2, 3, and 4 comprises a plurality of strips, each having a plurality of blocks.

For example, a first disk 1 comprises strip 0 having blocks 0 to 3, parity strip 1 having blocks 28 to 31, etc.

In this way, a plurality of blocks belonging to each of the disks 1 to 4 are regarded as a single strip.

Blocks belonging to the fourth disk 4 are parity blocks, and a parity block cluster, comprising parity block 12 10, parity block 13, parity block 14, and parity block 15 which are comprised in the fourth disk 4, is called parity strip 0 20.

Each parity block has a value obtained by performing an exclusive OR (XOR) operation on blocks located in the same row in the plurality of disks. For example, parity block 12 10 has a value obtained by performing an XOR operation on block 0 of the first disk 1, block 4 of the second disk 2, and block 8 of the third disk 3.

Parity blocks generated in this way are used to recover blocks in which an error has occurred.

When the plurality of independent disks 1 to 4 are arranged in parallel, strips located in the same row of the disks 1 to 4 are collectively called a single stripe.

For example, stripe 0 30 comprises strip 0 of the first disk 1, strip 1 of the second disk 2, strip 2 of the third disk 3, and parity strip 0 20 of the fourth disk 4.

In the same manner, stripe 1 comprises parity strip 1 located on the first disk 1, strip 0 located on the second disk 2, strip 1 located on the third disk 3, and strip 2 located on the fourth disk 4.

In two stripes that are adjacent to each other in the direction of columns (a longitudinal direction), a plurality of strips are arranged such that they are individually shifted by one column in a designated direction, that is, in the direction of rows (a lateral direction) (for example, in a rightward direction).

For example, when a plurality of strips are located in the sequence of strip 0, strip 1, strip 2, and parity strip 0 in the lateral direction in stripe 0 30 located in a first row, the strips are arranged in the sequence of parity strip 1, strip 0, strip 1, and strip 2 in the lateral direction in stripe 1 located in a second row.

Strip numbers assigned to a plurality of disks (for example, the first disk 1 to the third disk 3) which store blocks having identical characteristics (e.g., normal blocks other than a parity block) in stripe 0 30 that is the first stripe are sequentially increased in a direction in which strips are sequentially shifted by one column in the lateral direction (for example, in the rightward direction).

Increased strip numbers are assigned such that, in stripe 1 which is adjacent to the first stripe, that is, stripe 0, and in which strips are shifted from stripe 0 by one column, strip numbers are sequentially increased in the sequence of the second disk 2->third disk 3->fourth disk 4, and such that, in stripe 2, strip numbers are sequentially increased in the sequence of the third disk 3->fourth disk 4->first disk 1.

As described above, since the sequence of numbers assigned to the respective strips differs as the numbers of stripes located in the respective rows increase in the longitudinal direction, the sequence of numbers assigned to blocks located in the respective strips also differs.

The locations of first blocks (for example, block 0, block 16, . . . ) stored in first strips (for example, strip 0) in respective stripes are stored to be spaced apart from each other depending on locations to which the columns of strips are shifted.

For example, in the first stripe (stripe 0), the first block (block 0) stored in strip 0 is located on the first disk 1. In the second stripe (stripe 1), the first block (e.g., block 16) stored in strip 0 is located on the second disk 2 on which strip 0 is shifted by one column in the rightward direction, compared to the first stripe. In the third stripe (stripe 2), the first block stored in strip 0 is located on the third disk 3.

As described above with reference to FIG. 1, the spacing of strip locations with an increase in stripe number describes data arrangement of a typical RAID. The arrangement of stripes, strips, and blocks shown in FIG. 1 is only a single example, and the arrangement of the invention is not limited to such an example.

If the supply of power to the disk array having the above structure is interrupted while a write operation is being performed on the disk array, the consistency of stripes may be damaged. When a fault occurs in at least one of the plurality of disks 1 to 4 and data is recovered, correct data is not recovered in a stripe having lost consistency.

As described above, results obtained by performing an XOR operation on block 0 of strip 0, block 4 of strip 1, and block 8 of strip 2 are stored in the parity block 12 of parity strip 0.

When an error occurs in at least one of block 0, block 4, and block 8, the processor performs an operation of recovering the data of the block in which the error has occurred (hereinafter referred to as an ‘erroneous block’) using the parity block 12 and the remaining normal blocks (blocks in which no error occurs).

When block 0 is an erroneous block, and block 4, block 8, and parity block 12 are normal blocks, the value of the erroneous block, that is, block 0, is normally recovered using the values of the normal blocks, that is, block 4, block 8, and parity block 12.

When the supply of power is interrupted while data is being stored in block 0, block 4, block 8, and parity block 12, some of these blocks may complete a data storage operation, but some other blocks may not complete the data storage operation.

The resulting value obtained by performing an XOR operation on the values of block 0, block 4, and block 8 is not identical to the value of parity block 12. In this way, a stripe in which the resulting value of an XOR operation performed on the corresponding blocks is not identical to the value of the corresponding parity block is referred to as a ‘parity mismatch stripe.’

When an error occurs in a block present in such a parity mismatch stripe, the processor recovers the block in which the error has occurred. A procedure for promptly searching for a parity mismatch stripe and solving a parity mismatch is required.

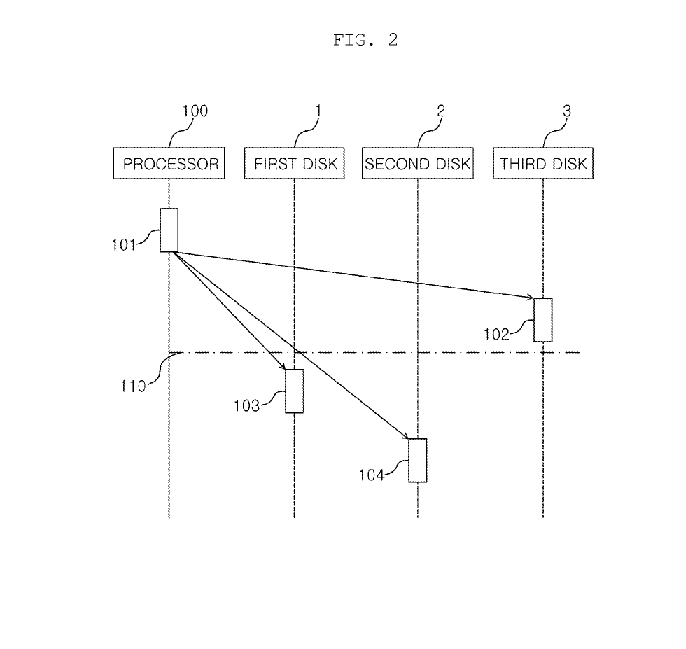

The operation of the disk array performed when the supply of power is interrupted while a write operation is being performed on the disk array will be described in detail with reference to FIG. 2.

Referring to FIG. 2, a processor 100, a first disk 1, a second disk 2, and a third disk 3 individually process data. In FIG. 2, dotted lines indicate states in which the processor 100, the first disk 1, the second disk 2, and the third disk 3 do not perform data processing operations, respectively. Reference numerals ‘101,’ ‘103,’ and ‘104’ denote states in which the corresponding instructions are being processed, and are hereinafter referred to as ‘active boxes.’ In the specification, the phrase ‘execute an active box’ means that the corresponding component 100, 1, 2, or 3 ‘processes the corresponding instruction.’

The processor 100 executes a first active box 101. In an embodiment, the first active box 101 individually transfers instructions required to perform a parity write operation of writing a value (that is, data) to a parity block present in the first disk 1, a data write operation of writing data to the second disk 2, and a data write operation of writing data to the third disk 3.

In FIG. 2, since the active box 101 is connected to the respective active boxes 102 to 104 of the first to third disks 1 to 3, the processor 100 transfers the instructions present in the active box 101 to the respective disks 1 to 3.

Due to this operation, in compliance with the instructions received from the processor 100, the third active box 103 of the first disk 1 performs a parity write operation, the fourth active box 104 of the second disk 2 performs a data write operation, and the second active box 102 of the third disk 3 performs a data write operation.

Since the respective disks 1 to 3 are not synchronized with each other, time points at which the active boxes 103, 104, and 102 are executed, that is, the time points at which corresponding data is written, may be different from each other.

When a moment 110 at which the supply of power to the disk array is interrupted occurs while the respective disks 1 to 3 perform the operation of writing corresponding data in compliance with the instructions received from the processor 100, it is assumed that, in a single example, the second active box 102 of the third disk 3 previously completes the data write operation before the interruption of power 110 occurs, but the third active box 103 and the fourth active box 104 of the first and second disks 1 and 2 do not complete the parity write operation and the data write operation due to the interruption of power 110.

The disk on which the data write operation has been completed (the third disk) and disks on which the write operation has not yet been completed (the first disk 1 and the second disk 2) are disposed in the same stripe. As a result, consistency between a parity which is a value stored in the parity block in the stripe and pieces of data which are values stored in normal blocks (e.g., block 0, block 4, and block 8) other than the parity block (e.g., parity block 12), is lost. Such a stripe recovers false data when an error occurs in a disk and data is recovered, and then it is impossible to verify whether the false data is true or false.

A stripe consistency (parity mismatch) check is required to allow the processor to check whether the consistency of stripes constituting the disk array is maintained or lost. Such a stripe consistency check is configured such that a parity (hereinafter referred to as a ‘temporary parity’) which is a value obtained by performing an XOR operation on pieces of data stored in the normal blocks (e.g., block 0, block 4, and block 8) comprised in the corresponding stripe is compared with a parity (hereinafter referred to as an ‘actual parity’) which is a value stored in the parity block (e.g., parity block 12) comprised in the corresponding stripe, and such that, if the temporary parity is identical to the actual parity, the processor obtains results indicating that the consistency of the stripe is maintained.

In another example, if the temporary parity obtained by performing an XOR operation on the pieces of data stored in the normal blocks comprised in the stripe is not identical to the actual parity stored in the parity block comprised in the corresponding stripe, the processor obtains results indicating that the consistency of the stripe is not maintained.

All stripes present in the disk array (RAID) must maintain their consistency. When the consistency of stripes is not maintained due to a mismatch between a temporary parity and an actual parity caused by the occurrence of an error, if a fault occurs in a relevant disk belonging to the RAID, data in the faulty and erroneous disk is not correctly recovered, as described above.

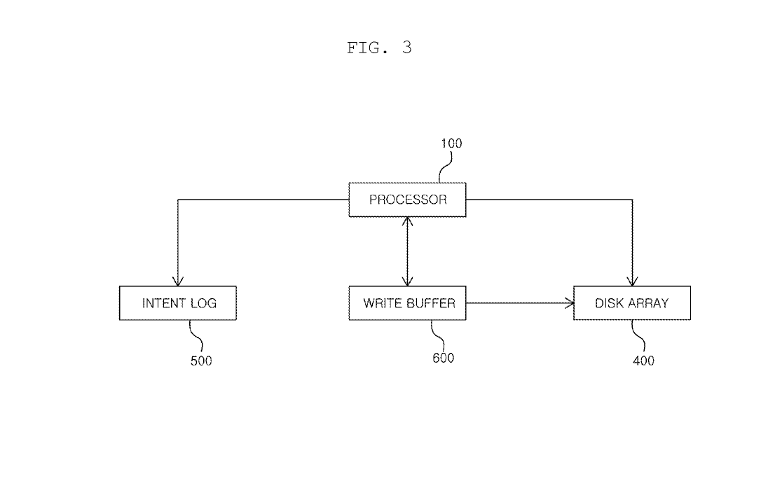

Next, the parity resynchronization operation of a disk array according to an embodiment of the invention will be described in detail with reference to FIGS. 3 to 5.

First, one embodiment of parity resynchronization in disk arrays will be described with reference to FIGS. 3 to 5.

Referring to FIG. 3, an apparatus for parity resynchronization in disk arrays according to an embodiment comprises a disk array 400 having a plurality of disks, a write buffer 600 connected to the disk array 400 and configured to store data in the disk array 400, at least one intent log 500 having the addresses of pieces of data stored in the write buffer 600, and a processor 100 configured to extract the address of data from the write buffer 600, store the data address in the intent log 500, store the data of the write buffer 600 in the disk array 400, and check the consistency of the stripes of the disk array 400.

As described above with reference to FIG. 1, the disk array 400 is implemented by forming a plurality of disks in the form of an array, and is provided with parity blocks for error recovery based on a stripe consistency check.

The processor 100 obtains the address of data to be buffered in the write buffer 600 and to be stored in the disk array 400, and stores the data address in the intent log 500.

The processor 100 controls the write buffer 600 so that data, the address of which has been stored in the intent log 500 among pieces of data buffered in the write buffer 600, is stored in the disk array 400 from the write buffer 600.

The processor 100 checks the consistency of stripes on the data stored in the disk array 400.

The intent log 500 is a list in which the addresses of pieces of data stored in the write buffer 600 are recorded, and may be stored in the disk array 400, or a separate nonvolatile storage device provided independently of the disk array 400, for example, a Hard Disk Drive (HDD) or a Solid-State Drive (SSD), the data of which is retained even if the supply of power is interrupted.

The intent log 500 obtains and stores the address of data which is to be buffered in the write buffer 600 and is to be stored in the disk of the disk array 400. Only the data, the address of which is stored in a recently generated intent log (hereinafter referred to as a ‘recent intent log’) 500 among a plurality of intent logs 500 can be stored in the disk array 400. In order to store data, the address of which is not registered in the recent intent log 500, in the disk array 400, a new intent log 500 having the address of the corresponding data desired to be stored in the disk array 400 must be generated.

The address of the data stored in the intent log 500 can be identified by the sector, the block, or the arbitrarily designated data unit.

As described above, the intent logs 500 are stored in the disk array 400 or a separate nonvolatile storage device, so that the intent logs 500 may be externally accessed, and a recent intent log 500 or intent logs 500 generated prior to the recent intent log 500 may be extracted.

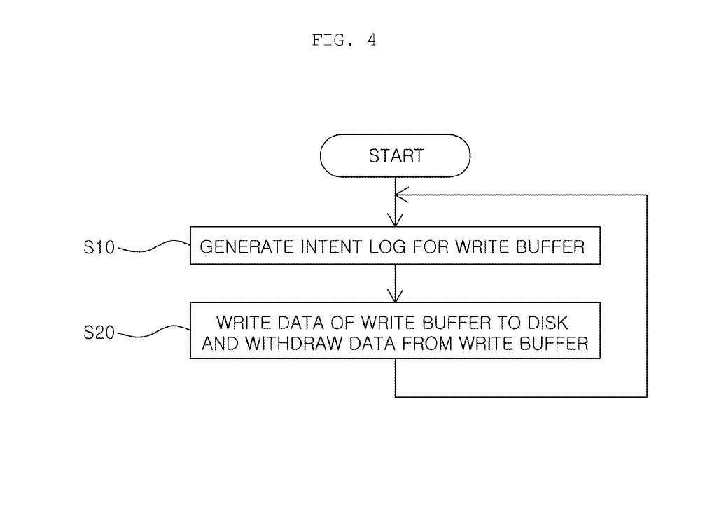

Below, the operation of the apparatus for parity resynchronization in disk arrays according to an embodiment will be described with reference to FIG. 4.

Referring to FIG. 4, a parity resynchronization method performed by the apparatus for parity resynchronization in disk arrays, having the configuration shown in FIG. 3, comprises the step S10 of generating at least one intent log 500 having a list of addresses of pieces of data buffered in the write buffer 600, and the step S20 of withdrawing data from the write buffer 600 while writing the data buffered in the write buffer 600 to disks.

The above steps S10 and S20 are sequentially processed, and the process is configured to return to step S10 of generating the intent log for the data buffered in the write buffer 600 after step S20 of writing the data buffered in the write buffer 600 to disks has been performed.

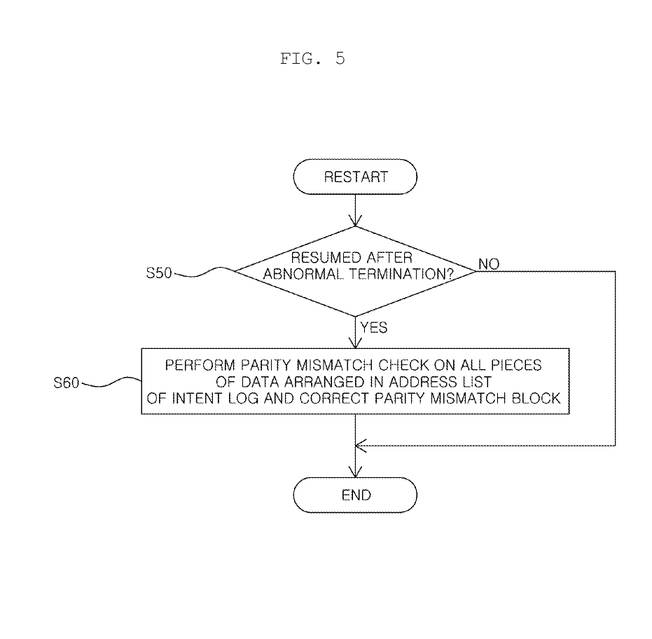

When the supply of power is abnormally terminated during the performance of steps S10 and S20 of FIG. 4, the processor 100 detects the abnormal termination of the disk array 400 at step S50 and resumes the operation of the disk array 400, as shown in FIG. 5.

When the operation of the disk array 400 is resumed in this way, the processor 100 performs operations corresponding to steps S50 and S60.

The processor 100 determines whether the operation of the disk array 400 has been resumed after having been abnormally terminated at step S50.

If it is determined that the operation of the disk array 400 has been resumed after having been abnormally terminated, the processor 100 performs a parity mismatch check (a stripe consistency check) on pieces of data of the disk array 400 corresponding to all pieces of data arranged in the address list of the intent logs 500.

In an example of the parity mismatch check performed by the processor 100, the processor 100 may calculate a temporary parity value for the data stored in the disk array 400, compare the calculated temporary parity value with an actual parity value stored in the corresponding parity block, and determine that the consistency of the corresponding stripe is maintained because the parities are matched if it is determined that the temporary parity value is identical to the actual parity value.

In another example of the parity mismatch check performed by the processor 100, if the temporary parity value is not identical to the actual parity value, it is determined that a parity mismatch block is comprised in the normal blocks of the corresponding stripe, and that the consistency of the stripe is not maintained. At this time, the processor 100 corrects the value of the parity mismatch block, in which abnormal data is stored due to the abnormal termination, using the normal blocks and the parity block stored in the corresponding stripe at step S60.

If it is not determined at the above step S50 that the operation of the disk array 400 has been resumed after having been abnormally terminated, the processor terminates the operation without performing a parity mismatch check.

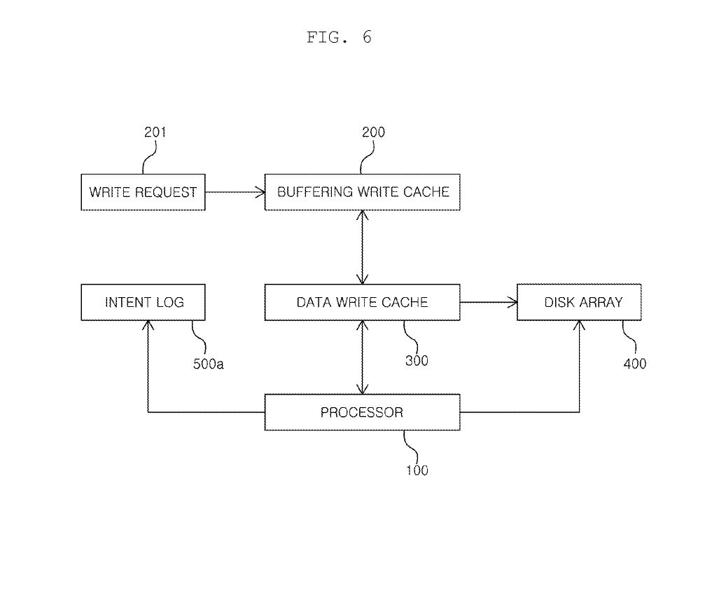

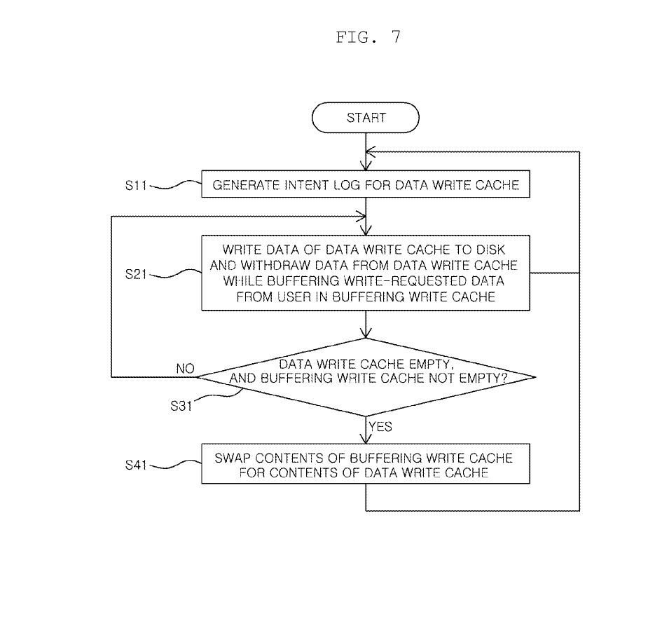

Next, an apparatus and method for parity resynchronization in disk arrays according to another embodiment will be described with reference to FIG. 5 as well as FIGS. 6 and 7.

Compared to FIG. 3, the same reference numerals are assigned to designate components having the same structure and performing the same operation as those of FIG. 3, and a detailed description thereof will be omitted.

First, referring to FIG. 6, the apparatus for parity resynchronization in disk arrays according to an embodiment comprises a Buffering Write Cache (BWC) 200, a Data Write Cache (DWC) 300 connected to the buffering write cache 200, a disk array 400 connected to the data write cache 300, at least one intent log 500a configured to extract the address of data from the data write cache 300 and have the data address, and a processor 100 configured to extract the address of data from the data write cache 300, store it in the intent log 500a, and check the consistency of the stripes of the disk array 400.

The buffering write cache 200 receives write-requested data 201 applied by a user (hereinafter referred to as ‘user data’) and stores the write-requested data.

The data write cache 300 stores data to be written to the disk array 400. In this case, the data write cache 300 receives data stored in the buffering write cache 200 and writes the data to the disk array 400.

As described above, the intent log 500a stores the addresses of pieces of data stored in the storage device. The intent log 500a according to an embodiment stores the addresses of pieces of data stored in the data write cache 300, unlike FIG. 3.

The intent log 500a does not store the addresses of data stored in the buffering write cache 200. The processor 100 stores the addresses of data, buffered in the data write cache 300, in the intent log 500a before storing the data buffered in the data write cache 300 in the corresponding disk of the disk array 400.

The addresses of data being written from the data write cache 300 to the disk of the disk array 400 are recorded in a recent intent log 500a.

When the supply of power is interrupted, the recent intent log 500a stores the addresses of pieces of data being written to the corresponding disk of the disk array 400 at a time point at which the interruption of the supply of power occurs.

After the supply of power resumes, the processor 100 performs a parity mismatch check on pieces of data present at the time point at which the interruption of the supply of power occurs, with reference to the list of addresses of pieces of data stored in the recent intent log 500a generated before the interruption of the supply of power occurs.

The processor 100 performs a parity mismatch check only on pieces of data related to data addresses provided in the finally stored intent log 500a.

After the power has been normally supplied, the processor 100 according to an embodiment performs the parity mismatch check only on data related to the data addresses provided in the finally stored intent log 500a, without performing the parity mismatch check on all stripes constituting the disk array 400, thus shortening the time required for the parity mismatch check.

There may occur a case where an abnormality may occur in the supply of power when the intent log 500a having the addresses of data buffered in the data write cache 300 is stored in a designated nonvolatile storage space, and false information is stored in the intent log 500a.

Since the intent log 500a according to an embodiment comprises a hash value created from the contents of the intent log 500a, the processor 100 may determine whether the data of the intent log 500a is true or false.

In an embodiment, the processor 100 stores the hash value of the intent log 500a at the last location of the intent log 500a. In this case, the processor 100 determines that the corresponding intent log 500a is invalid when the hash value of the intent log 500a is different from the hash value created from the pieces of data in the intent log 500a. In this case, the processor 100 sets an intent log 500a, stored just before the intent log 500a determined to be the invalid intent log, to the most recent intent log 500a.

Next, the operation of the apparatus for parity resynchronization in disk arrays, having the above configuration described with reference to FIG. 6, will be described in detail with reference to FIG. 5 together with FIG. 7.

Referring to FIG. 7, an intent log 500a for the data write cache 300 is generated at step S11.

The addresses of pieces of data stored in the data write cache 300 are arranged, and then a new intent log 500a is generated at step S11.

Then, data stored in the data write cache 300 is written to the disk array 400, and the data of the data write cache 300, which has been written to the disk array 400, is withdrawn from the data write cache 300. Simultaneously with this, the write-requested user data 201 provided by the user is buffered in the buffering write cache 200 at step S21.

Once the operation at step S21 of withdrawing the data from the data write cache 300 has been completed, the operation of the intent log generation step S11 is performed again, and it is determined whether the data write cache 300 and the buffering write cache 200 are empty at step S31.

If it is determined that the data write cache 300 is empty, but the buffering write cache 200 is not empty, the contents of the buffering write cache 200 and the contents of the data write cache 300 are swapped for each other at step S41.

At this time, since the data write cache 300 is empty, the user data of the buffering write cache 200 is moved to the data write cache 300.

According to step S41, if new data has been stored in the data write cache 300 that was empty, a new intent log 500a is generated for the data of the data write cache 300 at step S11.

If it is determined at step S31 that the data write cache 300 is not empty, data stored in the data write cache 300 is continuously written to the disk array 40 while being withdrawn from the data write cache 300 at step S21.

The above steps S11, S21, S31, and S41 are sequentially processed. When the supply of power is abnormally terminated during the performance of steps of FIG. 7, the processor detects the abnormal termination of the disk array 400, and resumes the operation of the disk array 400.

The operation performed when the operation of the disk array 400 is resumed is identical to that described above with reference to FIG. 5. When the abnormal termination of the disk array 400 occurs during the performance of the operation shown in FIG. 7, the processor performs a parity mismatch check on all pieces of data arranged in the address list of the intent log 500a, and corrects the value of a parity mismatch block which is a normal block where abnormal data is stored due to the abnormal termination.

As described above, the parity mismatch check performed in FIG. 5 is performed only on data corresponding to addresses stored in the intent log 500a, thus shortening the time required for parity resynchronization and efficiently performing parity resynchronization.

Although the preferred embodiments have been disclosed for illustrative purposes, those skilled in the art will appreciate that the scope of the invention is not limited to those embodiments, and various modifications, additions and substitutions derived from the basic concept of the invention defined by the accompanying claims are also comprised in the scope of the invention.

What is claimed is:

1. An apparatus for parity resynchronization in disk arrays, comprising:
a disk array comprising a plurality of disks and a plurality of stripes;
a write buffer for buffering pieces of data to be stored in the disk array;
an intent log comprising addresses of the pieces of data buffered in the write buffer; and
a processor for determining whether parity mismatch has occurred on the pieces of data corresponding to the data addresses stored in the intent log, and correcting an erroneous block corresponding to data on which it is determined that parity mismatch has occurred,
wherein the processor determines whether parity mismatch has occurred on the disk array or corrects the erroneous block using normal blocks and a parity block.

2. The apparatus of claim 1, wherein the pieces of data are written to the disk array after the addresses of the data have been stored in the intent log.

3. The apparatus of claim 1, wherein the intent log is stored in the disk array.

4. The apparatus of claim 1, wherein the intent log is stored in a nonvolatile storage device located independently of the disk array.

5. A method for parity resynchronization in disk arrays, comprising:
generating an intent log comprising a list of addresses of pieces of data stored in a data write cache;
writing the pieces of data of the data write cache to a disk while withdrawing the data from the data write cache; and
when supply of power is interrupted during writing of the data to the disk, a processor supplying power to the disk to resume an operation of the disk, checking whether parity mismatch has occurred on the data of the disk corresponding to the data address list stored in the intent log, and correcting a parity mismatch block using a parity block.

6. The method of claim 5, wherein generating the intent log, writing and withdrawing the data, and checking the parity mismatch on the data and correcting the parity mismatch block are sequentially processed.

7. An apparatus for parity resynchronization in disk arrays, comprising:
a disk array comprising a plurality of disks and a plurality of stripes;
a data write cache for storing pieces of data to be written to the disks;
a buffering write cache for buffering write-requested data;
an intent log comprising addresses of the pieces of data stored in the data write cache; and
a processor for determining whether parity mismatch has occurred on the pieces of data corresponding to the data addresses stored in the intent log, and correcting an erroneous block corresponding to data on which it is determined that parity mismatch has occurred,
wherein the processor determines whether parity mismatch has occurred on the disk array or corrects the erroneous block using normal blocks and a parity block.

8. A method for parity resynchronization in disk arrays, comprising:
generating an intent log comprising addresses of pieces of data stored in a data write cache;
writing the pieces of data of the data write cache to a disk while withdrawing the data from the data write cache, and buffering write-requested data provided by a user in a buffering write cache; and
when supply of power is interrupted while writing the pieces of data of the data write cache to the disk, a processor supplying power to the disk to resume an operation of the disk, checking whether parity mismatch has occurred on the data of the disk corresponding to the data address list stored in the intent log, and correcting a parity mismatch block using a parity block.

9. The method of claim 8, further comprising, after generating the intent log:
determining whether the data write cache is empty; and
swapping contents of the buffering write cache for contents of the data write cache.

10. The method of claim 9, wherein generating the intent log, determining the data, swapping the data, writing the data, and checking the parity mismatch on the data and correcting the parity mismatch block are sequentially processed.

11. The method of claim 9, wherein if swapping the data has been performed, performing again generating the intent log.
